(19) United States
(12) Patent Application Publication
(10) Pub. No.: US 2007/0247663 A1
(43) Pub. Date: Oct. 25, 2007

(54) IMAGE SAVING METHOD AND COMPUTER-READABLE MEDIUM THEREOF

(75) Inventors: Yao-Chang Huang, Taipei City (TW); Chang-Hung Lee, Yunlin County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/737,161

(22) Filed: Apr. 19, 2007

(30) Foreign Application Priority Data
Apr. 21, 2006 (TW) 95114383

(51) Int. Cl. G06K 15/00

(52) U.S. Cl. 358/1.16

(57) ABSTRACT

An image saving method and a computer-readable medium thereof. First, an image with a first image resolution is saved to a memory unit. Next, a parameter corresponding to the image is requested to be inputted. Then, a saving status of the memory unit is judged. Finally, when the saving status of the memory unit approaches a threshold value, the image with the first image resolution is automatically downsized to a downsized image with a second image resolution according to the parameter.

This application claims the benefit of Taiwan application Serial No. 95114383, filed Apr. 21, 2006, the subject matter of which is incorporated herein by reference.

### BACKGROUND OF THE INVENTION

1. Field of the Invention

The invention relates in general to an image saving method, and more particularly to an image saving method of automatically adjusting resolutions of images or automatically compressing the images before an available memory capacity is full.

2. Description of the Related Art

FIG. 1 (Prior Art) is a schematic illustration showing a conventional digital camera 110 and a peripheral device thereof. As shown in FIG. 1, the conventional digital camera 110 saves captured images to a memory card 120, and each image has the data quantity depending upon a resolution of the image. In other words, the data quantity of each image depends upon the length and the width of the image. For example, if the user sets the resolution of the conventional digital camera 110 as 2048×1024, then the data quantity of each image is about 1 to 2 Mbytes. Similarly, if the user sets the resolution of the conventional digital camera 110 as 1024×768, then the data quantity of each image is about 0.25 Mbytes.

Because the capacity of the memory card 120 is limited, the user has to purchase a card reader 130, insert the memory card 120 into the card reader 130 and then save the image data to a computer 140 when the residual capacity of the memory card 120 is not sufficient.

Alternatively, a USB transmission cable 150 may be used to couple a USB port of the conventional digital camera 110 to the computer 140, and then output the image data to the computer 140 through the USB transmission cable 150.

However, when the user goes outdoors and finds that the residual capacity of the memory card is insufficient, he or she can only view the existed images in the memory card 120 and delete some images painfully in a laborious manner, and the deleted images cannot be restored.

### SUMMARY OF THE INVENTION

The invention is directed to an image saving method of automatically adjusting resolutions of images or compressing the images before an available memory capacity is full. Because the data quantity of the images in a memory unit is correspondingly decreased, the user can keep each image and be free of the trouble caused by deleting some images.

According to a first aspect of the present invention, an image saving method is provided. The method includes the steps of: saving an image with a first image resolution to a memory unit; requesting a parameter corresponding to the image to be inputted; judging a saving status of the memory unit; and automatically scaling down the image with the first image resolution to a downsized image with a second image resolution according to the parameter when the saving status of the memory unit approaches a threshold value.

According to a second aspect of the present invention, an image saving method is provided. The method includes the steps of: saving an image with a first image data quantity to a memory unit; judging a saving status of the memory unit; and automatically compressing the image with the first image data quantity into a compressed image with a second image data quantity when the saving status of the memory unit approaches a threshold value.

According to a third aspect of the present invention, a computer-readable medium is provided. The computer-readable medium has a plurality of computer-executable commands for executing an image saving method. The image saving method includes the steps of: saving an image with a first image resolution to a memory unit; requesting a parameter corresponding to the image to be inputted; judging a saving status of the memory unit; and automatically scaling down the image with the first image resolution into a downsized image with a second image resolution according to the parameter when the saving status approaches a threshold value.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing a conventional digital camera and a peripheral device thereof.

FIG. 2 is a flow chart showing an image saving method according to a first embodiment of the invention.

FIG. 3 is a schematic illustration showing a threshold value setting frame.

FIG. 4 is a schematic illustration showing a first image resolution setting frame.

FIG. 5 is a schematic illustration showing a parameter setting frame.

FIG. 6 is a flow chart showing an image saving method according to a second embodiment of the invention.

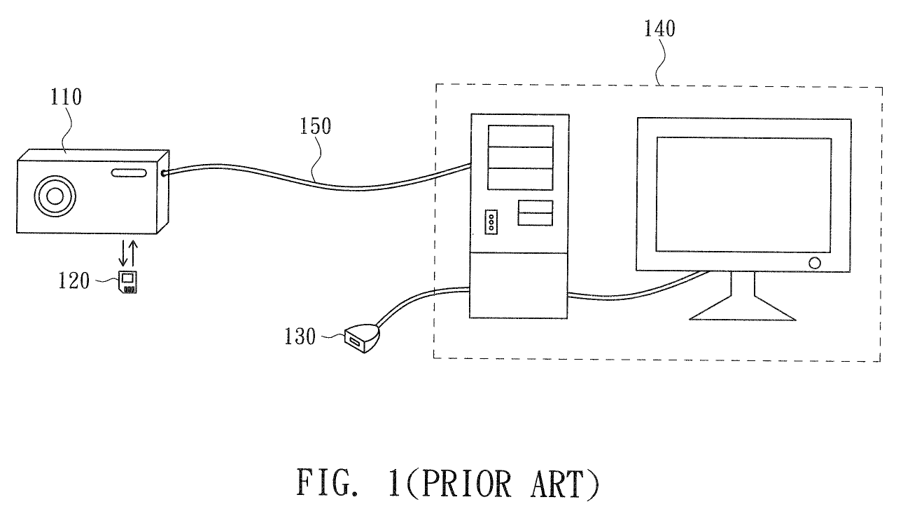

### DETAILED DESCRIPTION OF THE INVENTION

The image saving method of the invention is used in various electronic devices having memory unit, such as an image capturing device, which may be, for example, a digital camera (DC), a digital video (DV), a digital video recorder (DVR), a portable media player (PMP) with recording function or a surveillance system. By setting a threshold value in advance, the electronic device can automatically downsize the resolution of the previously saved image in the memory unit or compress the image when a saving status of the memory unit reaches the threshold value. Thus, the data quantity of the image in the memory unit may be reduced so that the available saving space may be increased correspondingly.

### First Embodiment

An image captured by the image capturing device may be saved to the memory unit with the resolution of 2048×1024, 1024×768, 800×600 or 640×320. In other words, the data quantity of the image in the memory unit changes with the change of the image size. In general, if the image with the resolution of 2048×1024 is to be saved to the memory unit, the memory space occupied by the image is about 1 to 2 Mbytes. If the same image with the resolution of 1024×512 is to be saved to the memory unit, the memory space occupied by the image is about 0.25 to 0.5 Mbytes.

Consequently, the memory spaces occupied by different resolutions of images are different. In order to prevent the inconvenience and trouble brought by deleting the image data, the image saving method of this embodiment automatically changes the resolution of the image before the available memory capacity is full so that the available memory capacity can be increased.

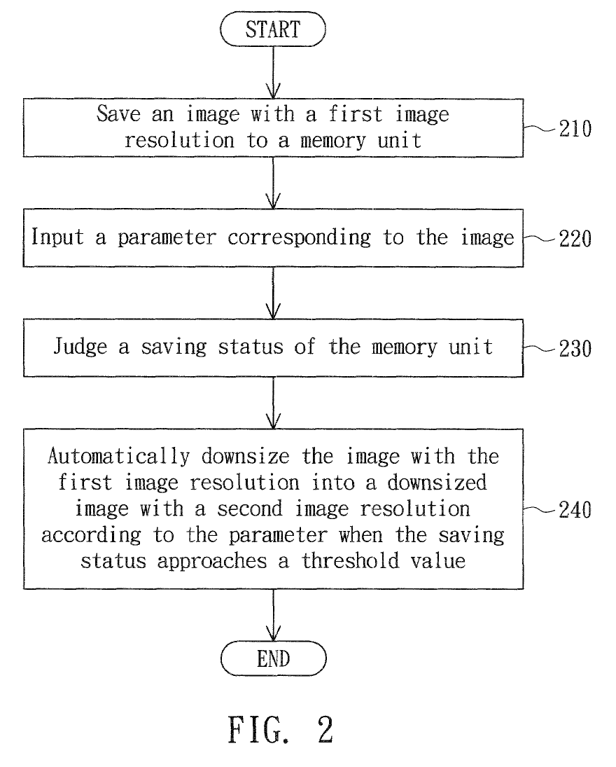

FIG. 2 is a flow chart showing an image saving method according to a first embodiment of the invention. Referring to FIG. 2, the image saving method of this embodiment includes the following steps. First, as shown in step 210, the electronic device saves the image with the first image resolution to the memory unit. In order to keep the image displaying quality, the first image resolution is preferably set as the best resolution of the electronic device. For example, if the best resolution of the electronic device is 2048×1024, the first image resolution is preferably set as 2048×1024.

Next, as shown in step 220, the electronic device displays a parameter setting frame to request the user to correspondingly input a parameter according to this image. The user may input the parameter, such as ½, ¼, ⅛ or 1/16, according to his/her favorite degree of this image. Before the size of the image is reduced, the user may momentarily change the parameter to adjust the size of the downsized image.

For example, if the user loves this image very much, he or she may correspondingly input the higher score, such as ½. On the contrary, if the user feels that this image is not so important, he or she may correspondingly input the lower score, such as 1/16. Thus, different parameters may be assigned to different images in the electronic device according to the favorite degree of the user.

Then, as shown in step 230, the residual memory capacity of the memory unit is getting smaller and smaller as the number of saved images in the memory unit is getting larger and larger, and the electronic device judges whether the saving status of the memory unit approaches the full status.

Finally, as shown in step 240, when the saving status of the memory unit approaches the threshold value, the electronic device automatically downsizes the image with the first image resolution into a downsized image with the second image resolution according to the parameter previously set by the user so that the memory space occupied by the images in the memory unit can be reduced. Or, when the saving status of the memory unit approaches the threshold value, the electronic device shows a message for the user to decide whether the downsize procedure is performed. Wherein, the message provides two option of yes and no. If the user chooses yes, the downsize procedure is performed. To the contrary, if the user chooses no, the downsize procedure isn't performed and the electronic device skips the message.

The threshold value may be, for example, a residual memory capacity, a residual memory capacity percentage, a saved data capacity or a saved data capacity percentage of the memory unit. For the sake of description, the following threshold value is the saved data capacity percentage of the memory unit.

For example, assume the threshold value is 90%, the first image resolution of the image is 2048×1024, and the user sets the parameter of the image as ½. When the saved data capacity percentage of the memory unit approaches 90%, the electronic device automatically downsizes the image in the memory unit into the downsized image with the resolution of 1024×512 according to the parameter so that the space occupied by the image in the memory unit is reduced to one fourth and the available memory capacity in the memory unit is correspondingly increased.

Consequently, when all the images in the memory unit is downsized according to the parameters, the memory capacity for saving the images can be greatly reduced. For example, before the image is downsized, the saved data capacity S of the memory unit is equal to

$${\sum }_{1}^{N} R ( n ) ,$$

wherein n is a positive integer and R(n) is the data quantity of each image. After the image is downsized, the saved data capacity S′ of the memory unit is equal to

$${\sum }_{1}^{N} C ( n ) \times R ( n )$$

and C(n) is the ratio for each image. The memory unit can release the memory space of (S−S′) after the images are downsized.

The threshold value and the first image resolution can be either inputted by the user or set as the default value of the electronic device so that the user can operate conveniently.

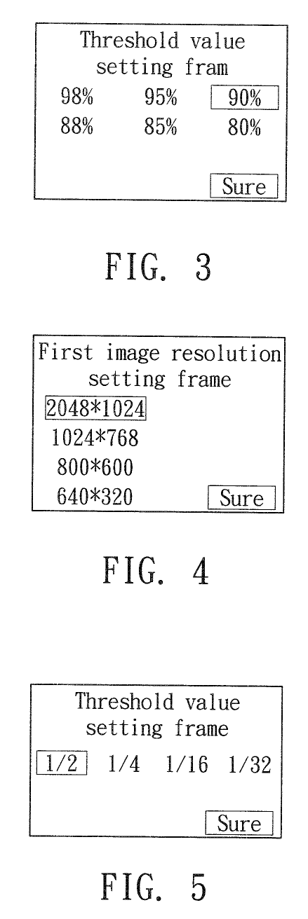

Please refer to FIGS. 3 to 5 simultaneously. FIG. 3 is a schematic illustration showing a threshold value setting frame. FIG. 4 is a schematic illustration showing a first image resolution setting frame. FIG. 5 is a schematic illustration showing a parameter setting frame.

If the threshold value, the first image resolution and the parameter are inputted by the user, the user may either input digits or make a selection to determine the threshold value, the first image resolution and the parameter.

As shown in FIG. 3, the threshold value setting frame provides six options of 98%, 95%, 90%, 88%, 85% and 80%. After the user selects the option of 90% and presses the “Sure” button, the threshold value may be set as 90%. When the saving status of the memory unit approaches 90%, the electronic device changes the resolution of the image according to the parameter.

As shown in FIG. 4, the first image resolution setting frame provides four options of 2048×1024, 1024×768, 800×600 and 640×320. After the user selects the option of 1024×768 and presses the “Sure” button, the first image resolution is set as 2048×1024. The image capturing device captures the image and saves the image with the resolution of 2048×1024 to the memory unit.

As shown in FIG. 5, the parameter setting frame provides four options of ½, ¼, ⅛ and 1/16. After the user selects the option of ½ and presses the “Sure” button, the parameter is set as ½. Thereafter, if the saving status of the memory unit approaches the threshold value, the electronic device changes the resolution of the image according to the parameter.

After the user has completed the setting according to the threshold value setting frame, the first image resolution setting frame and the parameter setting frame, the image capturing device saves the captured image with the resolution of 2048×1024 to the memory unit. With the number of the captured images becomes greater in the image capturing device, the residual memory capacity of the memory unit is correspondingly decreased. When the saving status of the memory unit approaches 90%, the electronic device automatically downsizes the image with the resolution of 2048×1024 to the downsized image with the resolution of 1024×768 according to the parameter so that the more available memory capacity of the memory unit can be released.

### Second Embodiment

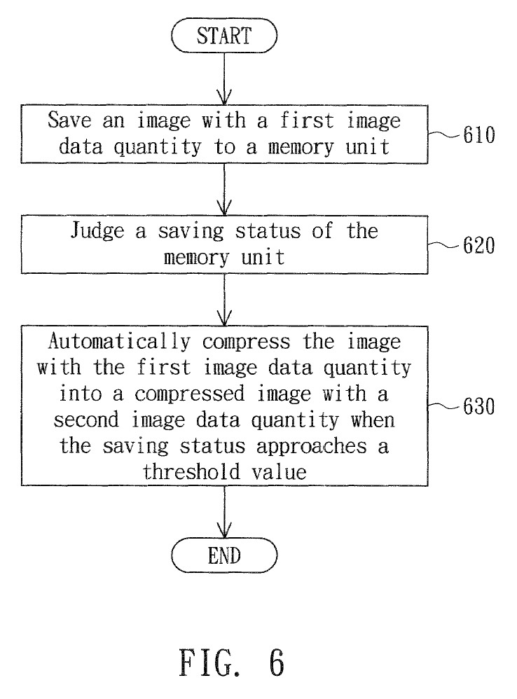

FIG. 6 is a flow chart showing an image saving method according to a second embodiment of the invention. When the saving status of the memory unit approaches a threshold value, the electronic device may also automatically compress the images in the memory unit so as to reduce the data quantity of the images and to provide more available memory capacity of the memory unit.

The image saving method includes the following steps. First, as shown in step 610, the electronic device saves the image with the first image data quantity to the memory unit.

Next, as shown in step 620, the residual memory capacity of the memory unit gets smaller as the number of saved images in the memory unit gets larger, and the electronic device judges whether the saving status of the memory unit approaches the full status.

Then, as shown in step 630, when the saving status of the memory unit approaches the threshold value, the method automatically compresses the image with the first image data quantity into the compressed image with the second image data quantity so that the larger available memory capacity of the memory unit may be released.

When the saving status of the memory unit approaches the threshold value, the electronic device may either downsize the images or compress the images so as to decrease the data quantity of the images in the memory unit and to correspondingly increase the available saving space. In addition, the image saving method may be saved in a computer-readable medium with a plurality of computer-executable commands, and the electronic device can execute the above-mentioned image saving method after the installation of the computer-readable medium.

In the image saving methods according to the embodiments of the invention, a threshold value is set in advance. When the saving status of the memory unit reaches the threshold value, the electronic device automatically downsizes the image resolutions of the previously saved images in the memory unit or compresses the images so that the data quantity of the images in the memory unit is reduced and the available memory space is increased.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image saving method, comprising:
(a) saving an image with a first image resolution to a memory unit;
(b) determining a parameter corresponding to the image; and
(c) changing the image with the first image resolution to a changed image with a second image resolution according to the parameter.

2. The method according to claim 1, further comprising:
(d) determining the first image resolution.

3. The method according to claim 1, further comprising:
(e) judging a saving status of the memory unit, and determining the second image resolution according to the parameter when the saving status approaches a threshold value.

4. The method according to claim 3, further comprising:
(f) determining the threshold value.

5. The method according to claim 3, wherein the first image resolution and the threshold value are default values.

6. The method according to claim 1, further comprising:
(g) judging a saving status of the memory unit; and
(h) when the saving status approaches a threshold value, showing a message to decide whether the step(c) is performed.

7. The method according to claim 1 being applied to a digital camera (DC).

8. The method according to claim 1 being applied to a digital video (DV).

9. The method according to claim 1 being applied to a surveillance system.

10. An image saving method, comprising:
(a) saving an image with a first image data quantity to a memory unit; and
(b) automatically compressing the image with the first image data quantity into a compressed image with a second image data quantity when a saving status of the memory unit approaches a threshold value.

11. The method according to claim 10, further comprising:
(c) determining the threshold value.

12. The method according to claim 10, further comprising:
(d) judging the saving status of the memory unit.

13. The method according to claim 10, wherein the threshold value is a default value.

14. The method according to claim 10 being applied to a digital camera (DC).

15. The method according to claim 10 being applied to a digital video (DV).

16. The method according to claim 10 being applied to a surveillance system.

17. An image saving method, comprising:
(a) saving a first group of images to a memory unit, the first group of images are correspond to a first parameter; and
(b) changing selectively the first group of images with the first image resolution to a changed first group of images with a second image resolution according to the first parameter when a saving status of the memory unit approaches a threshold value.

18. The method according to claim 17, further comprising:
(c) judging a saving status of the memory unit; and
(d) when the saving status approaches the threshold value, showing a message to decide whether the step(b) is performed.

19. The method according to claim 17, further comprising:
(e) saving a second group of images to the memory unit, the second group of images are correspond to a second parameter; and
(f) changing selectively the second group of images with the first image resolution to a changed second group of images with a third image resolution according to the second parameter when the saving status of the memory unit approaches the threshold value.

20. The method according to claim 19, further comprising:
(g) judging a saving status of the memory unit; and
(h) when the saving status approaches the threshold value, showing a message to decide whether the step(f) is performed.

21. The method according to claim 17, further comprising:
(i) determining the first image resolution.

22. The method according to claim 17, further comprising:
(j) determining the threshold value.

23. The method according to claim 17, wherein the first image resolution and the threshold value are default values.
